(19) United States
(12) Patent Application Publication
(10) Pub. No.: US 2012/0131440 A1
(43) Pub. Date: May 24, 2012

(54) Method For Context-Sensitive Presentation Of Patient-Related Information

(75) Inventor: Werner Rodorff, Scottsdale, AZ (US)

(73) Assignee: CompuGroup Medical AG, Koblenz (DE)

(21) Appl. No.: 13/130,193

(22) PCT Filed: Nov. 25, 2008
(86) PCT No.: PCT/EP2008/066138

§ 371 Date: Dec. 1, 2011

(51) Int. Cl. G06F 3/01; G06F 17/30

(52) U.S. Cl. 715/234; 715/781

(57) ABSTRACT

A computer-implemented method for displaying chronic illnesses on a graphical user interface of a data processing system, where the graphical user interface includes a first and a second display window.

The invention relates to a method for the context-sensitive provision of patient-related information on a graphical user interface in a data processing system, to a data processing system and to a computer program product.

Medical information systems document diverse, patient-related, administrative and medical data, inter alia. On the basis of continually growing medical knowledge and the complexity of the patent-related medical data collected by the doctor, modern medical information systems require the provision of by context-sensitive medical supporting systems, “Decision Support Systems” below, which support medical personnel in their daily work. In this connection, context-sensitive means that a doctor, while documenting the medically relevant data for a patient, is referred to particular circumstances or ranges of information which fit the context of the current medical treatment of the patient on the basis of administrative data, such as age, sex or diagnoses, findings, therapies, prescriptions, etc. Thus, such a system can provide reinforcing ranges of literature, most recent medical study results or other information, for example, or may refer to particular circumstances, such as possible intolerances for prescriptions or risks which fit the current pathological or treatment situation of the patient. Furthermore, general information, appropriate to the health situation of the patient, such as health or diet advice, can be provided. This therefore results in firstly the doctor being continuously supported by specialist advice whilst treating his patients, secondly, this has the advantage that the doctor does not need to perform an additional manual search in appropriate databases or relevant literature. This means that there is no waste of valuable system resources from medical information systems as a result of complex and generalized database searches, which significantly relieves the load on medical information systems, in particular, for example in hospitals having a multiplicity of computer terminals and access points.

US 2005/246314 A1 discloses a method and system for developing a personalized medical service for individual people or a group of people which can support the operation, adaptation and coordination of computer systems, software, products, services, data and much more.

By contrast, the object is based on providing an improved method for the context-sensitive provision of patient-related information on a graphical user interface in a data processing system, an improved data processing systems and an improved computer program product.

The objects on which the invention is based are each achieved by means of the features of the independent patent claims. Preferred embodiments of the invention are specified in the dependent patent claims.

The invention provides a method for the context-sensitive provision of patient-related information on a graphical user interface in a data processing system. In this case, the method comprises the step of receiving data from an application program, wherein the application program comprises a first display window on the graphical user interface, wherein the data contain patient data. In a further step, a first database is accessed, wherein the first database contains medical information objects, wherein the medical information objects are linked to query conditions for the received data, wherein the first database is contained in the data processing system. In a further step, the check is finally performed to determine whether at least one of the query conditions is satisfied, and a popup is produced on the graphical user interface if at least one of the query conditions is satisfied. In this case, the popup has the information objects which satisfy the query conditions, wherein a window focus is maintained on the first display window and wherein the popup is displayed on the graphical user interface such that further input of data in the first display window is not impaired. Subsequently, patient data are understood to mean data about the patient and about the treating doctor, the medical practice, etc.

In addition, ‘Medical Information Objects’ are subsequently understood to mean any kind of medical data, such as reinforcing ranges of literature, medical study results, possible intolerances, for prescriptions, risks which fit a particular pathological or treatment situation for a patient, hyperlinks to additional information on the internet or other medical databases, and also medicament information. Medical information objects may contain not only medical text information but also medical image information, such as exemplary X-ray images, photographic shots of visible pathological symptoms or else graphical representations of diagnosis methods and pathological profiles.

The method according to the invention has the advantage that the workflow of a user is not interrupted when using the application program, and the user is nevertheless referred to the information objects in targeted fashion. Furthermore, the method according to the invention has the advantage that medical information systems can remain unchanged in terms of their basic structure, i.e. in respect of the application program, with the first display window of said application program, while only query conditions and the first database are regularly updated with most recent information. This means that a program update in the classical sense is no longer necessary, and a database update is merely sufficient, the result of which is a significant reduction in the technical complexity both for users of the data processing systems in the form of medical information systems and for those service providers which provide compilations of ranges of information and information objects. It is therefore possible to tie new links and data contents to the connected application programs at arbitrary times without modifying the application programs themselves-one-off provision of an interface for the application programs to the decision support system is sufficient here.

In this case, particular consideration should be given to the fact that minimization of technical complexity is of particular relevance because the number of possible link components for medical information elements is extraordinarily high and subject to permanent change, since the range of information is increasing continually and more and more quickly.

In accordance with one embodiment of the invention, the popup also has a link to additional information, wherein user activation of the link involves the additional information being read from an information source and the read additional information being output in a second display window on the graphical user interface. In this case, the information source is the first database or a data source which is external to the data processing system, such as the internet and/or a further second database.

This means that a user is unrestricted in the decision to accept the range of information which appears in the popup, and hence to retrieve additional information upon request, by virtue of user activation of the link. In this case, the advantage of using an external data source, such as the internet and/or a further database, is that up-to-the-minute information can be provided in the second display window in the graphical user interface. By way of example, it is thus possible to update the first database only quarterly, which reduces the complexity for a user of the data processing system in terms of time and technical involvement. By contrast, the use of the external data source nevertheless ensures that, by way of example, up-to-date price information relating to medicaments, current clinical case studies, current recommendations, for example regarding inoculations for travel in particular countries, etc., can be provided.

In accordance with one embodiment of the invention, the popup is removed from the graphical user interface after a prescribed first time interval.

In accordance with a further embodiment of the invention, the additional information is stored in the database in the form of HTML or XML documents. In this case, the second display window is preferably a window in a web browser. The use of a window in a web browser as the second display window has the advantage that the method according to the invention for the context-sensitive provision of patient-related information can be implemented complementarily on almost any desired data processing system, since data processing systems nowadays have web browsers as standard. Hence, the application program merely needs to provide an interface which a decision support system running in the background uses to receive the data from the application program in order to subsequently provide the popups or additional information using the web browser.

In accordance with one embodiment of the invention, the data received from the first display window contain information about the user of the graphical user interface. In this case, the information about the user comprises practice master data and/or a medical specialist group and/or a user identifier.

In accordance with a further embodiment of the invention, the method also comprises the step of querying complementary patient data associated with the patient from a third database, wherein the third database is part of the data processing system or is an external database, wherein the medical information objects are additionally linked to query conditions for the queried complementary patient data.

The use of a third database for automatically querying complementary patient data associated with the patient has the advantage that the decision-making for the display content of the popups can also incorporate information which comes not just exclusively from the data processing system on which the application program is currently running. By way of example, a conceivable scenario is that a patient was previously in a medical practice and was then referred to a clinic which uses the method for the context-sensitive provision of patient-related information. In this case, when patient data are input by a doctor, for example, said complementary patient data associated with the patient are queried from the referring medical practice in the background in order to obtain a complete picture of the state of health, previous medication, medical history data, therapies, etc.

In accordance with one embodiment of the invention, the query conditions comprise personalized user query conditions and/or personalized patient query conditions, wherein the user query conditions and patient query conditions are complemented dynamically in the first database. This means that, by way of example, query conditions are used which are tailored in a quite specific manner to a treating doctor, for example in respect of his field of work (medical specialist group).

In accordance with one embodiment of the invention, the popup also has at least one display option which can be selected by the user, wherein selection of the display option involves the personalized user query condition and/or patient query condition being produced, wherein the personalized user query condition and/or patient query condition incorporate(s) the display option selected by the user. In a practical example, the display option is the immediate hiding and renewed showing of the popup after a prescribed selectable second time interval and/or is the immediate hiding of the popup without renewed showing of the popup. Thus, by way of example, the personalized user query condition can incorporate the fact that a piece of information shown by means of the popup is no longer used even for future data inputs by this specific doctor after the display option “immediate hiding without renewed showing” has been selected three times, for example, since in this case it can be assumed that the treating doctor is not at all interested in such information. The same can also be performed in a similar manner specifically for a particular patient, in which case a patient query condition is dynamically updated when the treating doctor selects that a particular proposal, for example regarding the administration of medicaments or therapy, is unsuitable for this patient.

In accordance with a further embodiment of the invention, the received data have data objects, wherein reception of the data involves the data objects being stored in a first stack, next, from a first table for the data objects stored in the first stack, identifiers associated with these data objects in the first table are read, wherein each identifier has an associated one of the medical information objects. In a further step, a second stack is used to store, for each identifier, the number of data objects stored in the first stack which are associated with this identifier in the first table. Finally, the query condition is deemed to be satisfied if the number of received data objects stored for an identifier in the second stack corresponds to the number of data objects which are associated with the identifier in the second table.

In accordance with one embodiment of the invention, a received data object is stored in the first stack only if the data object is not yet stored in the first stack.

The association of the identifiers with data objects in the first table in combination with the described use of the first and second stacks, and also the second table, has the advantage that a large number of query conditions can be checked in an extremely short time: instead of querying an entire database which stores various links and conditions together with appropriate information objects, it is merely necessary to access a single table and the two stacks in order to check received data objects for the query conditions. This allows the query conditions to be evaluated in real time, even when there is an extraordinarily large number of link possibilities for data objects and identifiers, as is the case for medical ranges of information. The use of a simple database query would use up enormous system resources, which can be avoided through the inventive use of the tables and stacks.

In a further aspect, the invention relates to a data processing system for the context-sensitive provision of patient-related information on a graphical user interface in the data processing system. In yet a further aspect, the invention relates to a computer program product having instructions which can be executed by a processor for the purpose of performing the method according to the invention for the context-sensitive provision of patient-related information on a graphical user interface in a data processing system.

Embodiments of the invention are explained in more detail below with reference to the drawings, in which:

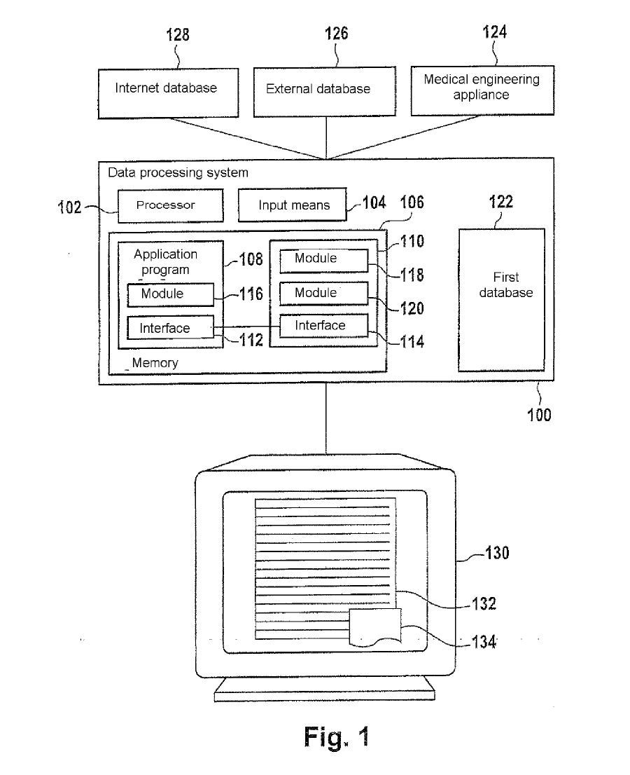

FIG. 1 shows a block diagram of a data processing system according to the invention,

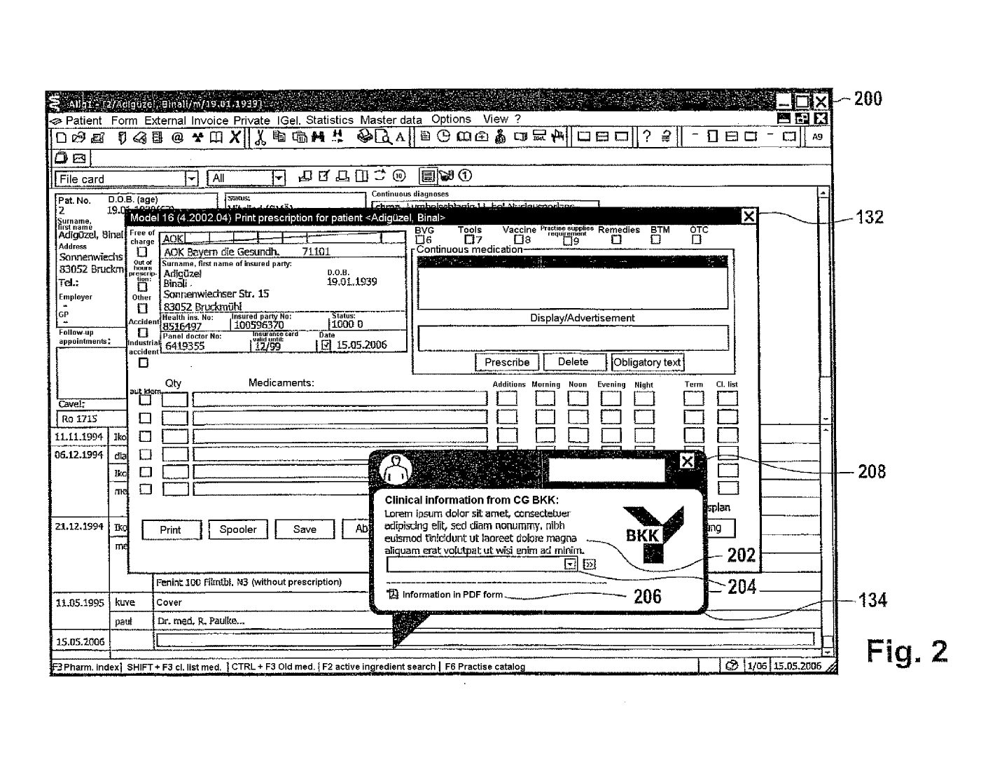

FIG. 2 shows a schematic view of a user interface with a popup,

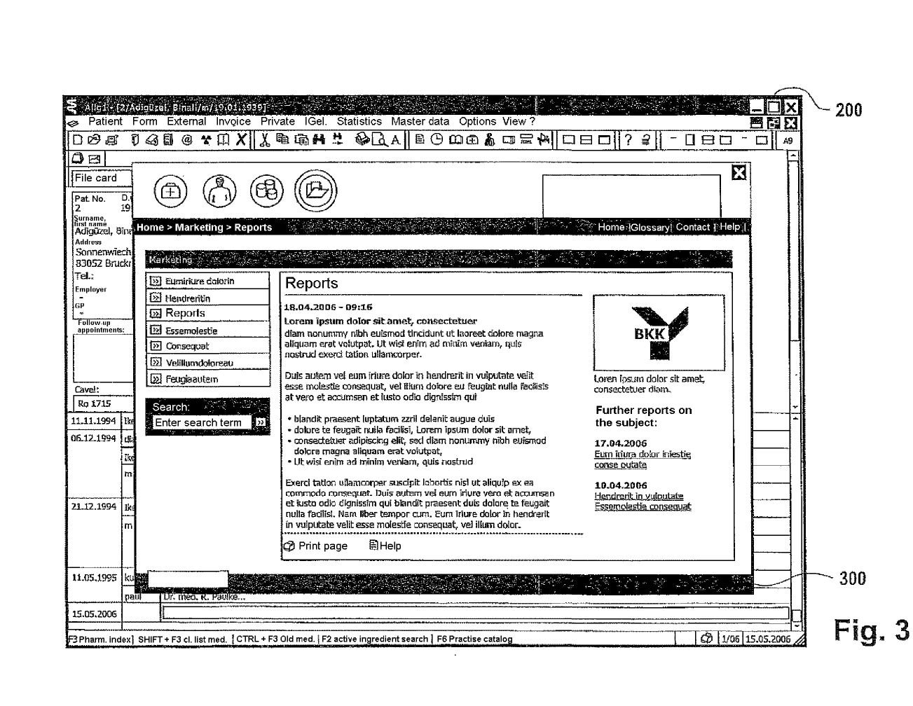

FIG. 3 shows a schematic view of a user interface with a second display window with additional information,

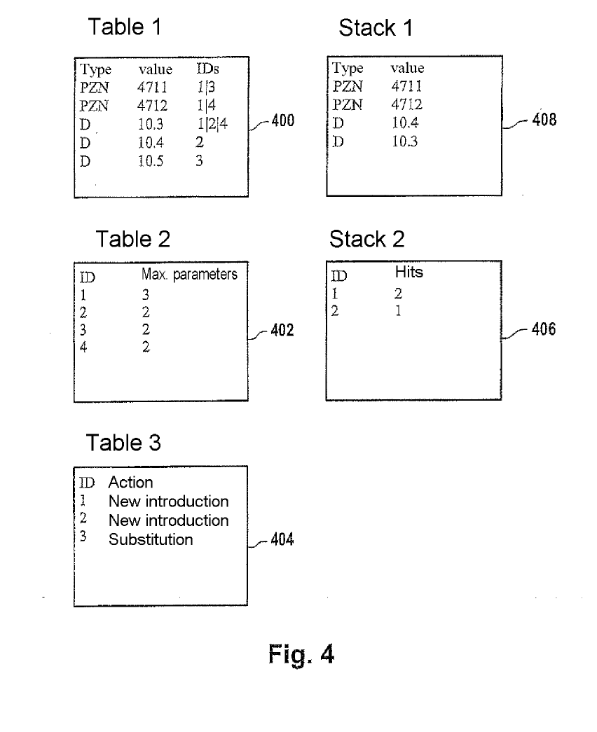

FIG. 4 shows an overview of the tables and stacks used in accordance with the invention,

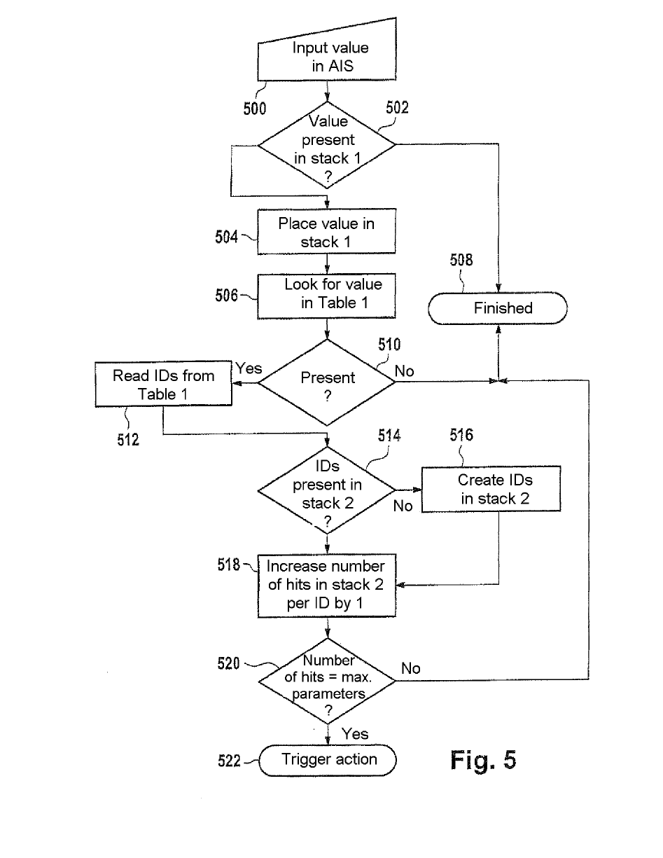

FIG. 5 shows a flowchart for the method according to the invention for the context-sensitive provision of patient-related information.

Subsequently, elements which are similar to one another are denoted by the same reference symbols.

FIG. 1 shows a block diagram of a data processing system 100 according to the invention. The data processing system 100 has a processor 102 and input means 104, such as a mouse, keyboard, etc. In addition, the data processing system 100 has a memory 106 which contains a computer-executable code for an application program 108 and a decision support system 110. Furthermore, the data processing system 100 comprises a first database 122, wherein the first database 122 contains medical information objects which are linked to query conditions for data which are received from the first application program 108 via its interface 112.

Also connected to the data processing system 100 are an internet database 128, an external database 126 and, by way of example, a medical appliance 124. In addition, the data processing system 100 has a display apparatus 130 in the form of a screen which, as shown in FIG. 1, shows a first display window 132 into which a treating doctor inputs patient data.

During the input of the patient data, these patient data are now forwarded from the application program 108 to the interface 114 of the decision support system 110 by means of the interface 112. Using the program modules 118 and 120, which are shown only schematically in FIG. 1, the decision support system 110 checks whether query conditions for the received data are satisfied. If this is the case then a popup 134 is produced on the graphical user interface of the display appliance 130, wherein the popup has information objects for which the query conditions are satisfied.

The decision support system 110 can also use its modules 118 and 120 to query additional data, for example from the external database 126, apart from the data which have been received from the first display window 132, said external database being the database of an external medical practice, a care service or the like, for example. In this case, in one embodiment, complementary patient data associated with the patient are retrieved from this external database 126. Furthermore, it is also possible, particularly in hospitals, in which the application program 108 is a hospital information system, to retrieve additional medical data for the patient directly from a medical engineering appliance 124, such as an X-ray appliance, an MRI scanner, etc. In this case, the popup 134 can also be used, by way of example, to make the doctor aware of an available X-ray picture, wherein the popup contains, for the doctor, a link to the X-ray pictures which are associated with the patient. In this case, X-ray image data, for example, are transmitted only when a treating doctor explicitly so requires after he has been made aware of the presence of such image data. This is highly relevant particularly in the case of hospital information systems, since this avoids an excessively high volume of data as a result of data transmissions on different client computers in the data processing system 100. This significantly reduces the overall system utilization level for such a hospital information system.

By way of example, the internet database 128 is used to provide a user, in the popup 134, with a link which, following activation, takes the user to an appropriate internet page with additional information.

An important factor in FIG. 1 is the logical separation of primary systems in the form of the application program 108, for example a doctor information system, hospital information system, dentist information system, etc., and the decision support system 110, so that both are software programs which operate separately from one another from the point of view of the underlying operating system. The application program 108 uses its interface 112, which ideally need no longer be changed once defined and implemented, to provide the decision support system 110 with all arising administrative and medical data in the course of treatment without further examination. The database 122, which is now integrated in the data processing system 100, has various links for medical information objects. One example: “if the patient's age is above 50, the sex is male and the diagnosis is I50.1, refer to the new study relating to . . . ”. If one or more such combinations arise, a hit is triggered in the decision support system 110. Each hit contains linked display and decision objects which are now displayed by the decision support system without interrupting the workflow of the user, in the form of a popup 134, also referred to as a “bubble”.

If the ranges of information which are presented to the user in the form of the popup 134 are not used by the treating doctor, these ranges or the popup automatically disappear after a configurable period of time.

Since links to the medical data objects, the hits to be triggered when the relevant combination arises and the ranges of information, including the information linked thereto itself, may all be held in the database 122 or alternatively in the internet database 128, for example, these context-sensitive links and information, including ranges of information, can be updated, modified and complemented by virtue of simple interchange of the relevant databases 122 or updates on the internet. Changes need to be made neither to the primary system in the form of the application program 108 nor to the decision support system in the form of the application program 110.

FIG. 2 shows a schematic view of a user interface 200 with a popup 134. In this case, the graphical user interface 200 has a first display window 132, which the doctor is currently using to issue an appropriate prescription for a patient. While the prescription data are being input, the popup 134 now appears on the graphical user interface 200, the popup being displayed on the graphical user interface such that a further input of data in the first display window is impaired as little as possible. Furthermore, the window focus continues to be contained on the first display window 132.

The popup 134 has an information object 202, for example additional information relating to the medicaments prescribed in a prescription in the form of side effects. When the popup 134 is displayed, the treating doctor now has various options. The simplest option is to operate the button 208, so that the popup 134 immediately disappears from the graphical user interface 200.

Alternatively, it is possible for the doctor to use one of the selection items with which he is provided by means of the dropdown menu 204. By way of example, such a selection option may be the option to no longer display the displayed information in future just specifically for this patient. This would correspond to what is known as a personalized patient query condition which, following selection of such an item in the dropdown menu, is dynamically complemented in the first database 122, as shown in FIG. 1. A further menu item in the dropdown menu 204 could be that the doctor in future no longer requires additional medicament information to be displayed just for a particular manufacturer. In this case, selection of such a dropdown menu item would satisfy a personalized user query condition, which is likewise complemented dynamically in the first database 122, as shown in FIG. 1. Furthermore, there are a multiplicity of options regarding which menu items the dropdown menu 204 could contain. This also includes, inter alia, the popup window 134 being hidden, for example, and appearing again on the graphical user interface 200 after variously selectable periods of time, for example after 5 minutes, 10 minutes or 20 minutes after the first display window 132 is closed.

In addition, the popup 134 has a link 206, wherein selection of the link 206 involves a second display window appearing on the graphical user interface 200, which display window displays additional information relating to the information objects 202.

FIG. 3 shows a schematic view of a user interface 200 with a second display window 300 with additional information. In this case, this second display window 300 is preferably a browser window, so that HTML files can immediately be presented thereby, as may be downloaded from appropriate internet databases, for example.

In one embodiment of the invention, it is also possible for the popups to be linked in connection with internet web services such that the popup proposes the use of a particular web service which is called in the second display window following confirmation of an appropriate button in the popup. By way of example, such a web service may be a service which writes a letter containing an appropriately worded personal salutation and instructions relating to the taking of medicaments using the patient's master data which are input in the first display window, such as surname, first name, address, age, insured person data, etc., and also using the medicaments prescribed by the doctor likewise in the first display window 132. In this case, the doctor no longer needs to write such an instructional letter himself, which firstly means less work for the doctor and secondly results in less system strain for the data processing system on which the doctor information system and the decision support system are being operated. A further example of the use of web services is, by way of example, the option, when referring a patient to hospital, of providing the doctor with the opportunity to use the web service to provide the patient with suitable directions to this hospital, including an outline of the approach, etc. Such data are usually not available on a doctor's computer on account of the complexity and scope of such map data, which means that in this case too the use of a web service actually allows an appropriate implementation in the first place.

A further example of the use of web services is that the referral diagnosis for in-patient treatment and the patient's place of residence (e.g. zipcode in the patient's master data) are taken as a basis for searching for a hospital which is suitable or specialized for the necessary treatment nearby. This information is then transmitted from the web service to the treating doctor.

FIG. 4 shows an overview of the tables and stacks used in accordance with the invention. Thus, the first table 400 contains three columns, where the first column indicates the type of data object, such as a central pharmaceutical number (PZN) or a diagnosis key (D). In this case, each entered data object has an associated appropriate value in the “value” column. In addition, each data object, comprising type and value, has an associated identifier (ID). As shown in the first table 400, a plurality of different identifiers may be associated with a data object in this case. By way of example, the central pharmaceutical number PZN with the value 4711 has both the identifier 1 and the identifier 3 associated with it. The diagnosis key 10.3 has three different associated identifiers, namely the identifiers 1, 2 and 4.

The second table 402 records, for each identifier (ID), the number of data objects for which the relevant identifier is respectively associated with different data objects in the first table 400. By way of example, in the first table 400, the identifier 1 is associated with three different data objects, namely the PZN 4711, PZN 4711 and D 10.3. In this case, PZN stands for the central pharmaceutical number of a medicament and D stands for a diagnosis. Hence, the identifier 1 is provided with the value 3 in the second table 402. In the same way, the respective number of data objects is calculated for the exemplary identifiers 2, 3 and 4 from the first table 400, this being the value 2 in all cases for ID=2, 3, 4.

The third table 404 now has, for each identifier, an appropriate action which needs to be presented to a user as an information object in the form of an appearing popup.

The use of the first and second stacks 408 and 406 which are shown in FIG. 4 will be explained below in connection with the flowchart in FIG. 5, which is a flowchart for the method according to the invention for the context-sensitive provision of patient-related information. However, it should be pointed out that this is merely one embodiment which can also be replaced by other suitable query mechanisms in order to check that query mechanisms are being satisfied.

Thus, in step 500, a data object is input in a first display window of the application program, for example of a doctor information system. Next, in step 402, a check is performed to determine whether this data object is already present in the first stack 408. If the data object is not yet present, an appropriate entry is made in the first stack 408 in step 504 and, in step 506, a check is then performed in the first table to determine whether it contains the data object associated with an identifier. If step 510 reveals that the data object is in fact already associated with one or more identifiers (IDs), the relevant IDs are read from the first table 400 in step 512.

A check is now performed in step 514 to determine whether entries relating to these identifiers already exist in the second stack 406. If this is not the case, the identifiers which are read from the first table in step 512 are successively stored in the second stack 406 and, moreover, for each identifier, the number of data objects which are stored in the first stack 408 and which are associated with this identifier in the first table 400 is added. In this case, this determination of the number of data objects stored in the first stack which are associated with this identifier in the first table corresponds to step 518 in FIG. 5. In step 516, the second stack 406 is merely used to store the relevant identifier, and in step 518 the relevant number of hits for the identifier is increased by 1. In the practical example in FIG. 4, it is the case, by way of example, that step 514 establishes with respect to the identifier ID=1 that said ID is already present in the second stack 406. In this case, the identifier ID=1 already has two hits which correspond to a previously effected input to the data objects PZN=4711 and PZN=4712 (cf. first stack 408).

Since the data object D=10.3 was now additionally input previously in steps 500 to 512, step 514 determines that the ID=1 with the number of hits=2 exists in the second stack 406. Since the data object D=10.3 is present both in the first stack 408 and in the first table 400, the number of hits for the identifier ID=1 is now increased by 1 in step 518. Next, in step 520, a check is now performed to determine whether the number of hits, now for the identifier ID=1 with hits=3, corresponds to the maximum number of data objects which are associated with this identifier ID=1 in the first table 400. A counting operation for the number of data objects which correspond to ID=1 in the first table is superfluous, since this value (max. parameters) can be read directly from the second table 402. If the result, as explained in the present example, is now that for the identifier ID=1 both the number of hits=3 also corresponds in the second table 402 to the identifier ID=1 with max. parameters=3, a corresponding action in the form of production of a popup is then triggered in step 522. If the result in step 520 is that the number does not correspond to the value max. parameters, the method ends in step 508.

Termination of the method likewise ends in step 508 if it has previously been determined in step 502 that an appropriate value which was input in the doctor information system in step 500 is already present in the first stack 408. In this case, the reason is that double counting of data objects which have already been input into the doctor information system is intended to be prevented in this way. Similarly, the method ends in step 508 if it is determined in step 510 that an appropriate data object which has been input into the doctor information system in step 500 does not exist in the first table 400 and hence is also not associated with an identifier.

It should also be pointed out that the second table 402 can also be produced by the first table 400 completely independently in respect of the maximum number of data objects which need to have a shared identifier ID.

### LIST OF REFERENCE SYMBOLS

100 Data processing system
102 Processor
104 Input means
106 Memory
108 Application program
110 Decision support system
112 Interface
114 Interface
116 Module
118 Module
120 Module
122 First database
124 Medical engineering appliance
126 External database
128 Internet database
130 Display apparatus
132 First display window
134 Popup
200 Graphical user interface
202 Information object
204 Dropdown menu
206 Link
208 Button
300 Second display window
400 First table
402 Second table
404 Third table
406 First stack
408 Second stack

1. A method for the context-sensitive provision of patient-related information on a graphical user interface in a data processing system, having the following steps:
receiving data from an application program, wherein the application program comprises a first display window on the graphical user interface, wherein the data contain patient data,
accessing a first database, wherein the first database contains medical information objects, wherein the medical information objects are medical data, wherein the first database contains query conditions which can be applied to the received data, wherein the medical information objects are associated with the query conditions, wherein the query conditions are queries, wherein the first database is contained in the data processing system,
performing a check to determine whether at least one of the query conditions is satisfied,
producing a popup on the graphical user interface if at least one of the query conditions is satisfied, wherein the popup has the information objects for which the query condition is satisfied, wherein a window focus is maintained on the first display window and wherein the popup is displayed on the graphical user interface such that further input of data in the first display window is allowed,
wherein the query conditions comprise personalized user query conditions and/or personalized patient query conditions, wherein the user query conditions and patient query conditions are complemented dynamically in the first database, wherein the popup also has at least one display option which can be selected by the user, wherein selection of the display option involves the personalized user query condition and/or patient query condition being produced, wherein the personalized user query condition and/or patient query condition incorporate(s) the display option selected by the user.

2. The method as claimed in claim 1, wherein the popup also has a link to additional information, wherein user activation of the link involves the additional information being read from an information source and the read additional information being output in a second display window on the graphical user interface.

3. The method as claimed in claim 2, wherein the information source is the first database or a data source which is external to the data processing system.

4. The method as claimed in claim 3, wherein the external data source is the internet and/or is a second database.

5. The method as claimed in claim 1, wherein the popup is removed from the graphical user interface after a prescribed first time interval.

6. The method as claimed in claim 1, wherein the additional information is stored in the database in the form of HTML or XML documents.

7. The method as claimed in claim 1, wherein the second display window is a window in a web browser.

8. The method as claimed in claim 1, wherein the data received from the first display window contain information about the user of the graphical user interface.

9. The method as claimed in claim 8, wherein the information about the user comprises practice master data and/or a medical specialist group and/or a user identifier.

10. The method as claimed in claim 1, also having the step of querying complementary patient data associated with the patient from a third database, wherein the third database is part of the data processing system or is an external database, wherein the medical information objects additionally have associated query conditions for the queried complementary patient data.

11. The method as claimed in claim 1, wherein the display option
is the immediate hiding and renewed showing of the popup after a prescribed or selectable second time interval and/or
is the immediate hiding of the popup without renewed showing.

12. The method as claimed in claim 1, wherein the received data have data objects, wherein
reception of the data involves the data objects being stored in a first stack,
from a first table for the data objects stored in the first stack, identifiers associated with these data objects in the first table are read, wherein each identifier has an associated one of the medical information objects,
a second stack is used to store, for each identifier, the number of data objects stored in the first stack which are associated with this identifier in the first table,
the query condition is satisfied if the number of received data objects stored for an identifier in the second stack corresponds to a prescribed number of data objects which are associated with the identifier in a second table.

13. The method as claimed in claim 12, wherein a received data object is stored in the first stack only if the data object is not yet stored in the first stack.

14. A data processing system for the context-sensitive provision of patient-related information on a graphical user interface in the data processing system, wherein the data processing system comprises:
means for receiving data from an application program, wherein the application program comprises a first display window on the graphical user interface, wherein the data contain patient data,
means for accessing a first database, wherein the first database contains medical information objects, wherein the medical information objects are medical data, wherein the first database contains query conditions which can be applied to the received data, wherein the medical information objects are associated with the query conditions, wherein the query conditions are queries, wherein the first database is contained in the data processing system,
means for checking whether at least one of the query conditions is satisfied,
means for producing a popup on the graphical user interface if at least one of the query conditions is satisfied, wherein the popup has the information objects from which the query condition is satisfied, wherein the means for producing the popup are designed such that a window focus is maintained on the first display window, and that the popup is displayed on the graphical user interface such that further input of data in the first display window is not impaired, also has at least one display option which can be selected by the user, wherein selection of the display option involves the personalized user query condition and/or patient query condition being produced, wherein the personalized user query condition and/or patient query condition incorporate(s) the display option selected by the user.

15. The data processing system as claimed in claim 14, also having means for querying complementary patient data associated with the patient from a third database, wherein the third database is part of the data processing system or is an external database, wherein the medical information objects are additionally linked to query conditions for the queried complementary patient data.

16. The data processing system as claimed in claim 14, wherein the received data have data objects, also having
means for storing the data objects upon reception of the data in a first stack,
means for reading identifiers from a first table, wherein in the first table the identifiers are associated with the data objects stored in the first stack, wherein each identifier has an associated one of the medical information objects,
means for storing, for each identifier, the number of data objects stored in the first stack in a second stack, wherein the query condition is satisfied if the number of received data objects stored for an identifier in the second stack corresponds to a prescribed number of data objects which are associated with the identifier in a second table.

17. A non-transitory, computer-readable storage medium containing a computer program instructions which can be executed by a processor for the purpose of performing a method for the context-sensitive provision of patient-related information on a graphical user interface in a data processing system, the method comprising the steps of:
receiving data from an application program, wherein the application program comprises a first display window on the graphical user interface, wherein the data contain patient data,
accessing a first database, wherein the first database contains medical information objects, wherein the medical information objects are medical data, wherein the first database contains query conditions which can be applied to the received data, wherein the medical information objects are associated with the query conditions, wherein the query conditions are queries, wherein the first database is contained in the data processing system,
performing a check to determine whether at least one of the query conditions is satisfied,
a popup is produced on the graphical user interface if at least one of the query conditions is satisfied, wherein the popup has the information objects for which the query condition is satisfied, wherein a window focus is maintained on the first display window and wherein the popup is displayed on the graphical user interface such that further input of data in the first display window is allowed,
wherein the query conditions comprise personalized user query conditions and/or personalized patient query conditions, wherein the user query conditions and patient query conditions are complemented dynamically in the first database, wherein the popup also has at least one display option which can be selected by the user, wherein selection of the display option involves the personalized user query condition and/or patient query condition being produced, wherein the personalized user query condition and/or patient query condition incorporate(s) the display option selected by the user.
